(19) United States
(12) Patent Application Publication
(10) Pub. No.: US 2009/0257842 A1
(43) Pub. Date: Oct. 15, 2009

(54) Bolt device for coupling two pieces of lumber

(76) Inventor: Wen-Hong Lo, Yong-An Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,559

(22) Filed: Apr. 13, 2009

(30) Foreign Application Priority Data
Apr. 14, 2008 (TW) 097206357

(51) Int. Cl. F16B 29/00

(52) U.S. Cl. 411/44

(57) ABSTRACT

A bolt device includes a bolt and a jacket. The bolt includes in sequence a threaded section, an enveloped section, a neck portion, and a tool-coupling end section. The tool-coupling end section includes an end face for coupling with a tool to screw the threaded section into a first piece of lumber. The jacket is mounted around the enveloped section, the neck portion, and the tool-coupling section. The jacket includes a first hook in an area in alignment with the neck portion of the bolt. The jacket and the enveloped section, the neck portion, and the tool-coupling section of the bolt are adapted to be driven into a second piece of lumber, with the first hook in frictional contact with the second piece of lumber.

### BACKGROUND OF THE INVENTION

The present invention relates to a bolt device and, more particularly, to a bolt device for coupling two pieces of lumber.

It is well known to use a bolt to combine lumber or the like for making a piece of furniture or for decoration purposes. In a conventional approach, a bolt is extended from an outer side of a first piece of lumber into a second piece of lumber, with an end face of the bolt exposed outside and thus adversely affecting the appearance of the furniture or decoration.

To avoid exposure of the bolt, a device has been proposed and includes a bolt and a plastic jacket mounted around a portion of the bolt. The bolt includes outer threading allowing it to be screwed into a first piece of lumber. The jacket includes a plurality of annular inclined ribs on an outer periphery thereof. After the bolt is screwed into the first piece of lumber, the first piece of lumber is hammered to drive the exposed portion of the bolt and the jacket into a second piece of lumber. The annular inclined ribs are shaped to allow easy insertion into the second piece of lumber and to make movement of the annular inclined ribs out of the second piece of lumber difficult. The toughness characteristics of the plastic jacket provide a catching effect to the lumber. Such a jacket has a shape corresponding to an enveloped section, a neck portion, and a tool-coupling end section of the bolt. However, a portion of the outer periphery of the jacket in alignment with the neck portion of the jacket lacks friction such that the portion of the outer periphery of the jacket can not reliably catch the second piece of lumber after entering the second piece of lumber.

### SUMMARY OF THE INVENTION

A bolt device in accordance with the present invention includes a bolt and a jacket. The bolt includes in sequence a threaded section, an enveloped section, a neck portion, and a tool-coupling end section. The tool-coupling end section includes an end face for coupling with a tool to screw the threaded section into a first piece of lumber. The jacket is mounted around the enveloped section, the neck portion, and the tool-coupling section. The jacket includes a first hook in an area in alignment with the neck portion of the bolt. The jacket and the enveloped section, the neck portion, and the tool-coupling section of the bolt are adapted to be driven into a second piece of lumber, with the first hook in frictional contact with the second piece of lumber.

In a most preferred form, the jacket further includes a second hook in the area in alignment with the neck portion of the bolt. The second hook is in frictional contact with the second piece of lumber. The enveloped section includes an embossed section firmly coupled with the jacket. The embossed section of the bolt can be coupled with an inner periphery of the jacket by adhesive, ultrasonic bonding, or high-frequency bonding as a single piece. The bolt further includes a flange formed between the enveloped section and the threaded section. The jacket presses against and is stopped and positioned by the flange.

Other objectives, advantages, and novel features of the invention will become more apparent from the following detailed description when taken in conjunction with the accompanying drawings.

### BRIEF DESCRIPTION OF THE DRAWINGS

FIG. 1 shows a perspective view of a bolt device in accordance with the present invention.

FIG. 2 shows an exploded perspective view of the bolt device of FIG. 1.

FIG. 3 shows a cross sectional view of the bolt device of FIG. 1 according to section line A-A of FIG. 1.

FIG. 3A shows an enlarged view of a circled portion of FIG. 3.

FIG. 4 shows a cross sectional view of the bolt device of FIG. 1 according to section line B-B of FIG. 1.

FIG. 4A shows an enlarged view of a circled portion of FIG. 4.

FIG. 5 is an exploded perspective view of the bolt device of FIG. 1 and two pieces of lumber to be coupled together by the bolt device.

FIG. 6 shows a cross sectional view of the bolt device and the articles of FIG. 5 after coupling.

### DETAILED DESCRIPTION OF THE INVENTION

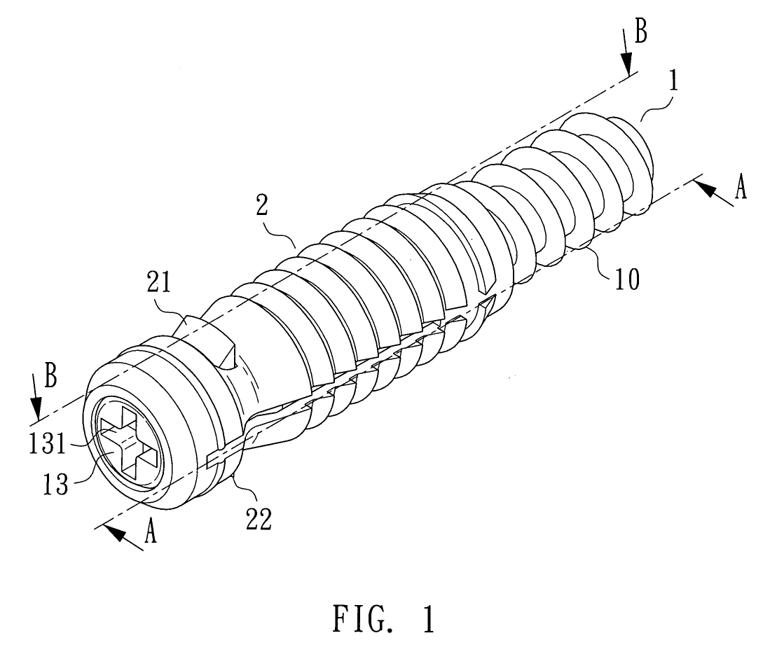

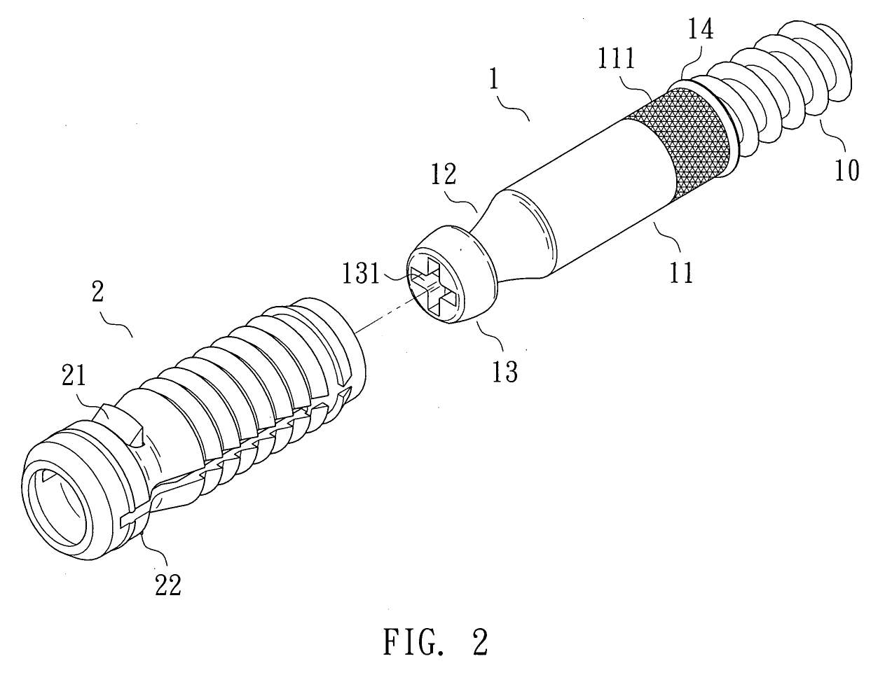

Referring to FIGS. 1 to 3, a bolt device in accordance with the present invention includes a bolt 1 and a jacket 2. According to the preferred form shown, bolt 1 includes in sequence a threaded section 10, an enveloped section 11, a neck portion 12, and a tool-coupling end section 13. Tool-coupling end section 13 includes an end face 131 into which a tool such as a screwdriver can be inserted and coupled. Enveloped section 11 includes an embossed section 111 to provide firm coupling with jacket 2 mounted therearound. Thus, bolt 1 and jacket 2 are securely coupled together. A flange 14 is formed between enveloped section 11 and threaded section 10. Flange 14 provides a positioning effect for jacket 2.

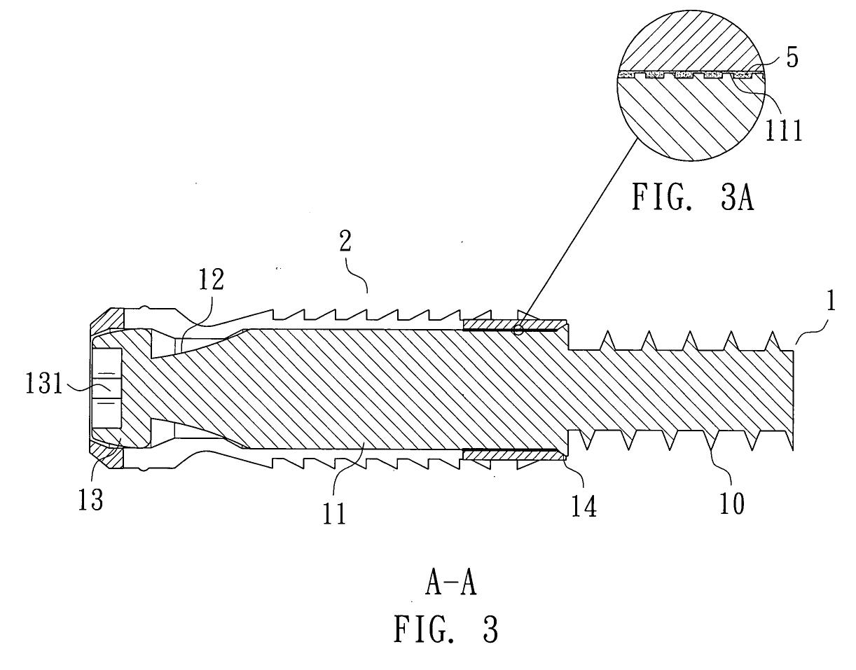

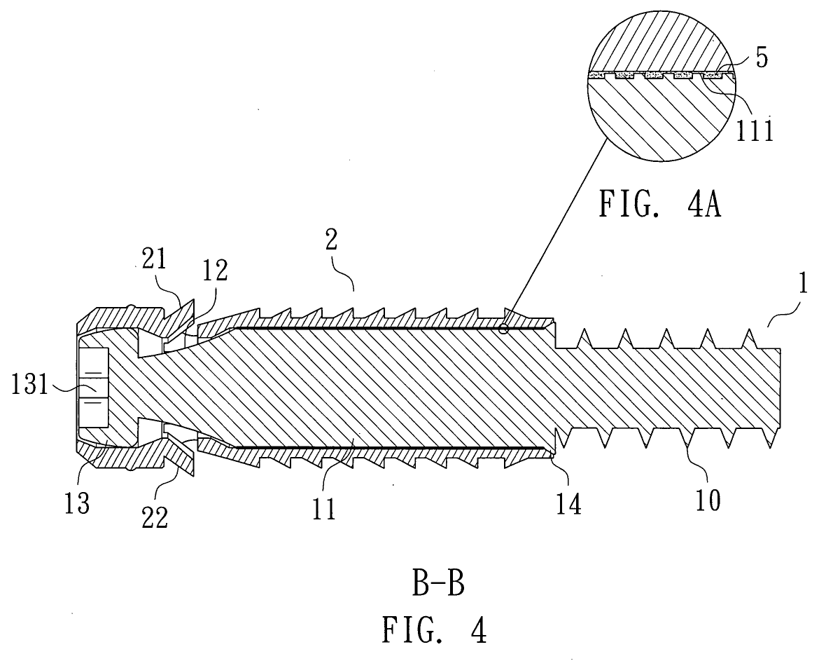

Jacket 2 is cylindrical and hollow and has a shape corresponding to and mounted around enveloped section 11, neck portion 12, and tool-coupling end section 13 of bolt 1. Note that an end of jacket 2 presses against and is stopped and positioned by the flange 14. Jacket 2 includes a first hook 21 on an outer periphery thereof in an area in alignment with neck portion 12 of bolt 1. A second hook 22 can be formed in the area to allow even distribution of force. Embossed section 111 of bolt 1 is coupled with an inner periphery of jacket 2 by adhesive 5 (see FIGS. 3 and 3A). Thus, embossed section 111 of bolt 1 is coupled with the inner periphery of jacket 2 as a single piece. However, embossed section 11 of bolt 1 can be coupled with the inner periphery of jacket 2 by tight coupling, ultrasonic bonding, or high-frequency bonding.

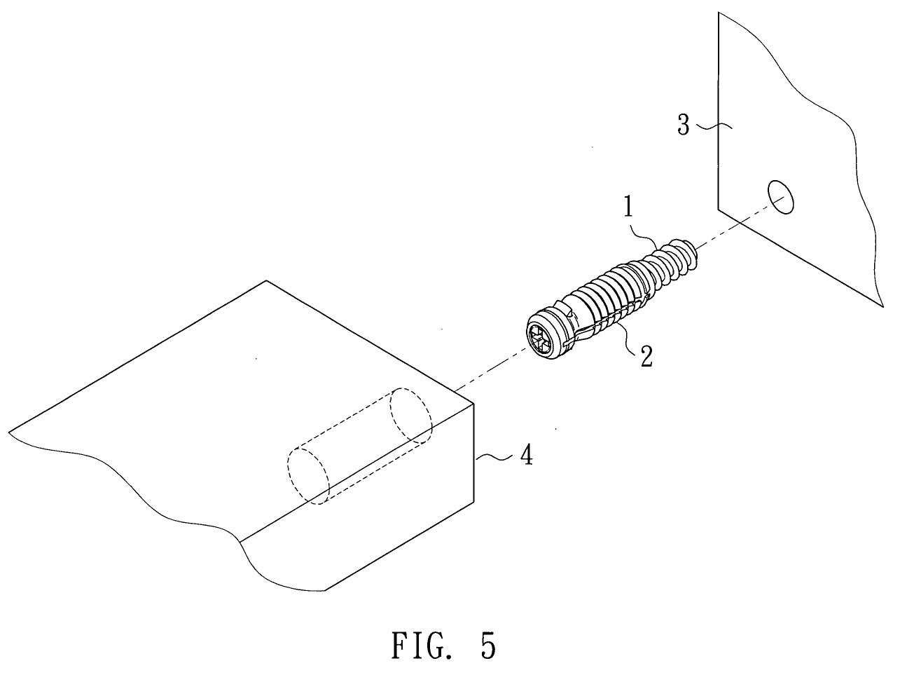

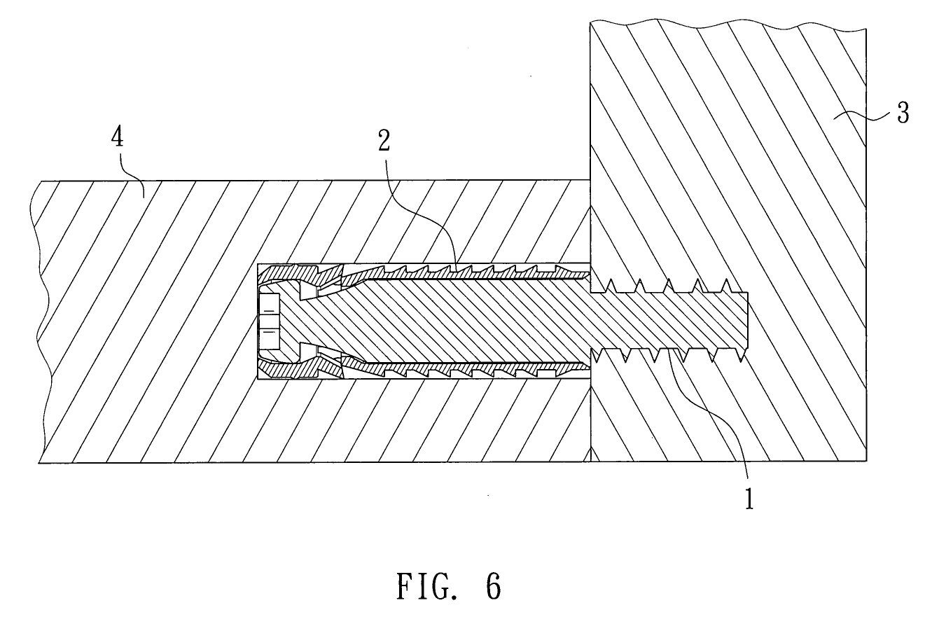

With reference to FIGS. 5 and 6, threaded section 10 of bolt 1 is firstly screwed into a first piece of lumber 3 by a tool such as a screwdriver that is coupled with end face 131 of tool-coupling section 13. Next, first piece of lumber 3 is hammered to drive jacket 2 and enveloped section 11, neck portion 12, and tool-coupling section 13 of bolt 1 into a second piece of lumber 4. Since bolt 1 and jacket 2 are secured together as a single piece, disengagement is less likely to occur when bolt 1 and jacket 2 are respectively driven into first and second pieces of lumber 3 and 4. Thus, loosening, sliding, and disengagement of bolt 1 and jacket 2 from first and second pieces of lumber 3, 4 are less likely to occur. Furthermore, hooks 21, 22 are in frictional contact with second piece of lumber 4 and, thus, can reliably catch and engage with second piece of lumber 4.

Although a specific embodiment has been illustrated and described, numerous modifications and variations are still possible without departing from the essence of the invention. The scope of the invention is limited by the accompanying claims.

1. A bolt device comprising:
a bolt including in sequence a threaded section, an enveloped section, a neck portion, and a tool-coupling end section, with the tool-coupling end section including an end face for coupling with a tool to screw the threaded section into a first piece of lumber; and
a jacket mounted around the enveloped section, the neck portion, and the tool-coupling section, with the jacket including a first hook in an area in alignment with the neck portion of the bolt, with the jacket and the enveloped section, the neck portion, and the tool-coupling section of the bolt being adapted to be driven into a second piece of lumber, with the first hook being adapted to be in frictional contact with the second piece of lumber.

2. The bolt device as claimed in claim 1, with the jacket further including a second hook in the area in alignment with the neck portion of the bolt, with the second hook being adapted to be in frictional contact with the second piece of lumber.

3. The bolt device as claimed in claim 1, with the enveloped section including an embossed section firmly coupled with the jacket mounted therearound.

4. The bolt device as claimed in claim 3, with the embossed section of the bolt being coupled with an inner periphery of the jacket by adhesive, ultrasonic bonding, or high-frequency bonding as a single piece.

5. The bolt device as claimed in claim 1, with the bolt further including a flange formed between the enveloped section and the threaded section, and with the jacket pressing against and being stopped and positioned by the flange.
